(19) United States
(12) Patent Application Publication
(10) Pub. No.: US 2004/0063796 A1
(43) Pub. Date: Apr. 1, 2004

(54) High ionic strength tolerant thickening systems and products formulated therewith

(76) Inventors: Anthony E. Winston, East Brunswick, NJ (US); Willie J. Carter, Sugar Land, TX (US)

Correspondence Address: Irving M. Fishman, Suite 1422, North Tower, 89 Headquarters Plaza, Morristown, NJ, 07960, US

(21) Appl. No.: 10/262,205

(22) Filed: Sep. 30, 2002

(51) Int. Cl. B01F 3/12

(52) U.S. Cl. 516/79

(57) ABSTRACT

A pseudo-plastic or thixotropic carrier having anti-malodorous components dissolved or suspended therein is sprayed on the internal surfaces of an ostomy bag or pouch. The viscoelastic properties of the carrier allow the composition to be conveniently dispensed from a spray bottle into the ostomy bag and retained on the inner walls thereof without being displaced therefrom by incoming waste during use of the ostomy bag. This allows the composition to continue to deodorize the ostomy bag headspace even after waste material begins to fill the bag.

### CROSS-REFERENCE TO RELATED APPLICATIONS

Not Applicable

### STATEMENT REGARDING FEDERALLY SPONSORED RESEARCH OR DEVELOPMENT

Not Applicable

### FIELD OF THE INVENTION

The present invention relates to the field of inorganic thickeners, particularly inorganic thickeners for use in systems of high ionic strength.

### BACKGROUND OF THE INVENTION

Inorganic thickeners, typically clays, are utilized in a variety of compositions for their ability to modify the rheology of the compositions into which they are incorporated. Virtually any type of semi solid formulation can be found to have clay thickeners, either alone or in combination with organic thickening polymers. In general thickening clays are composed, in the dry state, of platelets arranged in stacks with sheets of silica alternating generally with magnesium and lithium containing sheets. Other metals may also be present to varying degrees in the internal structure of the clay. When dispersed in water, the gross particle that results ends up having a negative charge distributed on the top and bottom of the particle (the broad faces) and the sides connecting those surfaces generally have positive charges distributed on them.

When modest concentrations of thickening clays are added to water they form very low viscosity suspensions. The addition of monovalent electrolytes (such as alkali metal salts) thickens these suspensions at low to moderate ionic strength to form pseudoplastic gels. A pseudoplastic gel is one with a high stationary viscosity (i.e. when not subjected to shear the product is essentially a paste with good stands up) but when subjected to shear, the viscosity drops and the paste becomes a thin solution allowing it to be dispensed, for example, as a fine spray. However, when the electrolyte concentration is increased past a critical point, additional electrolyte results in the gel thinning and eventually when even more electrolyte is added the gel collapses and the liquid becomes water thin. At this point the clay particles separate and drop to the bottom of the container. The pseudoplastic properties of thickening clays are highly desirable for many uses. While a degree of pseudoplasticity is exhibited by some organic thickeners, the most highly pseudoplastic gels are prepared with clays. Unfortunately, many systems in which the pseudoplastic properties of clays would be highly desirable, have high ionic strength and therefore cannot be prepared with clays. In such instances organic thickeners must be used and inferior properties result. Given the above, it would be highly desirable to modify clay thickener systems to make them more tolerant of high ionic strength systems and still provide the desired rheology.

### OBJECTS OF THE INVENTION

It is among the objects of the present invention to provide a modified clay system that maintains excellent pseudoplastic thickening characteristics when formulated into high ionic strength formulations.

Another object of the invention is to provide a modified clay thickener system that, in addition to thickening, is simultaneously capable of potentially providing a deodorizing benefit.

Still another object of the invention is to potentially provide a modified clay thickener system that, in addition to thickening, is simultaneously capable of providing disinfectant activity.

Yet another object of the invention is to provide formulations which can utilize the modified clay to provide a disinfectant or deodorizing activity in addition to improved rheology so as to reduce the amount or need for other deodorants and/or other disinfectants.

Still other objects of the invention will be recognized by those of ordinary skill in the art.

### BRIEF SUMMARY OF THE INVENTION

These objects are surprisingly achieved by a clay suspension in which the suspended clay has been “externally reacted” with a metal cation selected from divalent, trivalent, and tetravalent metal cations to an extent that the ratio of metal cation to clay is within the range to produce a viscosity between about 10 to 100% of the maximum viscosity observed in a plot of viscosity vs. ratio of metal cation to clay used. By “externally reacted” we mean reacted with the clay suspension in such a way that the metal ion does not get incorporated within the clay structure itself but reacts with the outside of the clay particles. Once the clay suspension has been reacted in this manner (hereinafter the “externally reacted” clay), it can be utilized in formulations having monovalent metal electrolytes present at ionic strengths which would have collapsed the clay thickening system in the absence of the external reaction

### BRIEF DESCRIPTION OF THE DRAWING

Not Applicable

### DETAILED DESCRIPTION OF THE INVENTION

The present invention provides for a modified clay thickener system for use with high ionic strength formulations. The invention also provides modified clay in formulations, which themselves may not be of high ionic strength, but which might encounter high ionic strength during the intended use of the formulation, but that require that the rheology imparted by the clay be maintained during the use of the product.

The invention is a thickening system of a clay suspension in which the suspended clay has been “externally reacted” with a metal cation selected from divalent, trivalent, and tetravalent metal cations to an extent that the ratio of metal cation to clay is within the range to produce a viscosity between about 10 to 100%, preferably 20 to 100%, more preferably 40 to 100%, still more preferably, 60-100%, yet even more preferably 80-100%, even more preferably 90-100%, most preferably 95-100% of the maximum viscosity observed in a plot of viscosity vs. ratio of metal cation to clay used. By “externally reacted” we mean reacted with the clay suspension in such a way that the metal ion does not get incorporated within the clay structure itself but reacts with the outside of the clay particles. Once the clay suspension has been reacted in this manner (hereinafter the “externally reacted” clay), it can be utilized in formulations having monovalent metal electrolytes present at ionic strengths which would have collapsed the clay thickening system in the absence of the external reaction

The clays for use in the invention are natural or synthetic clays. While actual preferred ranges for the amount of clay will vary from product to product, amounts of up to 10% of the respective formulation, preferably about 2% to about 6% of the formulation, more preferably, about 3% to about 5%, and most preferably about 4% of the formulation are not a typical. Nonetheless, one of ordinary skill will readily know to what extent the clay should be used in a particular formulation.

The particle size of the clays used for this invention depend on the source of clay used. The optimum natural thickening clays used for this invention have a particle size of generally not more than about 500 nm, preferable between 100 and 300 nm and more preferably about 200 nanometer. Optimum synthetic clays for this invention have particle sizes less than 500 nm, preferably less than 200 nm and most preferably between about 15 to about 100 nm in diameter. The clay particles used as thickening clays for this invention are often in the form of thin discs of thickness of the order of 1 nm. Thus a typical synthetic clay may have a diameter of 25 nm and a thickness of 1 nm. While any clay may be used, those generally classified as smectite clays are preferred. A particularly suitable clay is sodium lithium magnesium silicate based colloidal clay similar to hectorite. The preferred synthetic clays are available from Southern Clay Products under the name Laponite and the preferred natural clays are sold under the names Veegum and Van Gel available from Vanderbilt Minerals Corp. Notwithstanding the foregoing, magnesium aluminum silicate based clays are also suitable.

The clay is reacted externally as a suspension in water with about 1×10⁻⁵ moles to 2×10⁻³ moles of a divalent, trivalent, or tetravalent metal cation; preferably a member selected from the group consisting of calcium, magnesium, strontium, barium, zinc, copper, manganese and iron; even more preferably zinc, copper, and iron (II) per gram of clay. Preferably the divalent, trivalent, and tetravalent metal cations are present in an amount of a salt thereof at about 2×1 0-5 moles to 1.67×10⁻³ moles, more preferably 4×10⁻⁵ moles to 8×10⁻⁴ moles of such metal cation per gram of clay. The metal cation is supplied by any suitable salt thereof compatible with the balance of the system in which it will be used and the end use (with the external reaction being carried out in situ).

In general, the external reaction is carried out by dispersing the clay in water and initially hydrating it, preferably in a high shear mixer. The dispersion is preferably heated to from about 40° C. to about 80° C., preferably to about 60° C. and rapidly stirring for about 10 minutes to about 2 hours, preferably about 30 minutes. Optimum temperatures and mixing times vary depending on the type and quantity of clay used. Following hydration, while rapidly mixing a solution containing about 1% to about 5% of a divalent, trivalent of tetravalent metal is added and the mixture is mixed from about an additional 5 minutes to about 1 hour preferably for about 15 minutes to produce the externally reacted clay suspension. This latter reaction can be performed on the hot hydrated clay suspension or the hydrated clay can initially be cooled to room temperature. The externally reacted clay suspension should at this point be a thickened liquid or preferably a gel. At this point the gel is then ready for incorporation of the rest of the formulation ingredients as desired for its final use. After the addition of each formulation ingredient the mixture is preferably mixed for 2 to 30 minutes preferably 5 minutes to assure adequate dispersion. If ionic materials are added they may need to be added slowly and/or as a diluted solution to prevent localized areas of extreme ionic strength which collapse the gel. If it is desired to incorporated polymeric organic thickening agents requiring hydration into the suspension, it may be preferable to incorporate them into the water phase prior to the hydration of the clay. The particular choice of procedure is mandated by many factors that are particular to the individual formulation being prepared.

In many instances, to prevent syneresis, it is desirable to include a small amount of an auxiliary organic polymer thickener. Typical materials for this purpose include (but are not limited to) carboxymethylcellulose (and its alkali metal salts), polyacrylates, xanthan gum, guar gum, and sodium alginate, preferably polyacrylates (preferably of molecular weight of about 100,000 to about 2,000,000) and xanthan gum. These auxiliary thickeners are typically added at not more than about 2%, preferably 0 to about 0.2%, more preferably about 0.01% to about 0.2%, still more preferably about 0.025 to about 0.1%, more preferably 0.04% to about 0.08%, most preferably about 0.05% organic polymer based on the weight of the complete formulation.

One of the major advantages of the modified clay is that it can tolerate the presence of monovalent metal ion containing compounds in ionic strengths which could not be tolerated without the external reaction. This now allows for the use of clay thickeners in formulations or under use conditions where high ionic strength conditions, especially those due to monovalent cations, prevail. In addition, where the modifying metal cation is one which has a deodorizing and/or bacteriocidal activity of its own, that activity is surprisingly maintained even though the metal cation has modified the clay. Hence, the modified clay may now be used in contexts where such bacteriocidal and or deodorizing properties are desirable with either less or no separate bacteriocidal or deodorizing component. This is especially advantageous where the other necessary components or the particular use conditions make the incorporation of other bacteriocides and/or deodorizers undesirable or unsuitable.

In preferred formulations of the invention ionic materials are added for the specific benefits they impart.

The following table provides examples of ionic materials which might be useful for the invention.

| Performance enhancing Ionic material | Purpose |
|---|---|
| Alkali metal bicarbonates, carbonates, | pH buffer, deodorizer, |
| silicates, phosphate | cleaner etc. |
| Alkali metal hydroxide | alkali, saponifier cleaner etc |
| Anionic surfactant | cleaning/wetting agent etc |
| Alkali metal sulfites, nitrites | reducing agent, corrosion |
| | inhibitor etc |
| Alkali metal hypochlorite, chlorite, | oxidizer, whitener, bactericide |
| chloramine-t, chloramine-b | etc |
| Alkali metal cyanurate | chlorine stabilizer etc. |

As shown in the above table, sodium bicarbonate might be added for its deodorizing benefits, its ability to promote cleaning or as a pH buffer. Similarly, Alkali hydroxides (including, without limitation, sodium hydroxide, potassium hydroxide, and ammonium hydroxide) might be added for their ability to remove burned on fats from oven walls. Hypochlorite salts might be added for their ability to kill bacteria on surfaces or to bleach them. Desirably the ionic materials are added at more than 0.001 mole ions per liter and up to 4 mole ions per liter. For example, useful concentrations of sodium bicarbonate for deodorization would be between about 0.1% to about 5%, useful concentrations of alkali hydroxides for oven cleaners would be between 0.5% to about 5%, useful concentrations of hypochlorites for disinfecting and bleaching would be between 0.01% and 6%.

In preferred embodiments using Laponite as the clay, the externally reacted clay suitably forms a pseudo-plastic or thixotropic liquid. By “thixotropic liquid” we mean a liquid which has a viscosity which reduces under shear. However, in contrast to a perfectly pseudoplastic liquid, which regains all of its stationary viscosity when the shear stress is removed, the viscosity of a thixotropic gel does not immediately return to its original value when the shear stress is removed. While pseudoplastic properties are the most desired for this invention almost all real systems will exhibit some degree of thixotropy and this is acceptable. The kinetic viscosity of the pseudoplastic or thixotropic liquid is very low, typically not more than about 2,000 cps, preferably not more than about 1,500 cps, more preferably not more than about 1,000 cps, still more preferably not more than about 500 cps, even more preferably, not more than about 100 cps, even still more preferably not more than about 50 cps, and most preferably not more than about 20 cps. The kinetic viscosity of the liquid has no minimum level, but typically is at least about 1 cps, more preferably at least about 2 cps. The low kinetic viscosity allows for the pseudo-plastic or thixotropic liquid (along with materials dissolved or dispersed therein) to be readily sprayed from a spray bottle or aerosol dispenser. In contrast, the stationary viscosity of the pseudoplastic or thixotropic liquid is quite high, typically at least about 10,000 cps, preferably at least about 15,000 cps, more preferably at least about 20,000 cps. While there is no required maximum for the stationary viscosity, it is typically not more than about 1,000,000 cps, more typically not more than about 500,000 cps, more typically not more than about 300,000 cps, even more typically not more than about 150,000 cps. The larger stationary viscosity permits the composition, upon being deposited on the intended surface, to stay where deposited and not be dislodged or washed away from the surface on which it was deposited during ordinary conditions of use.

Such a formulation can be made to readily flow out of a dispenser by means other than spray and aerosol, making the product suitable as a base for toothpastes, bath gels, hand soaps, cosmetic formulations, moisturizers, household formulations, detergent pastes, pre-spotter detergent paste, deodorizers and ostomy deodorizers, oven cleaner etc. Because such systems can have high stationary viscosity and low kinetic viscosity, they can be utilized in a number of contexts where ordinary containers might not be as suitable. For example, with respect to “travel size” fluid and semi-solid materials, there is often concern that once the package is opened, packing it into one's luggage along with clothing might result in the package leaking and ruining clothing etc. Since products prepared with modified clays of the invention have typically high stationary viscosity, they are not likely to leak absent a catastrophic rupture of the container. However, absent the external modification of the clay by the di, tri, or tetravalent metal cation, these viscoelastic properties are not maintained at high ionic strength. In many cases, the most desirable products that one would like to take advantage of those properties are products which have high ionic strength. It is for these high ionic strength formulations that the present invention is most advantageous and fulfills a substantial unmet need. This need is especially important in the current climate in the travel context, as more and more, travelers are being required to leave many items in their checked luggage, rather than taking them in carry on bags. Additional information on compatible chlorinating agents for deodorizers can be found in the Inventor's copending US patent application Docket No. 49602/000, entitled Deodorant Product Containing chlorinating Agents and Buffered Alkaline Salts, while specific information with respect to ostomy deodorizers may be found in the Inventor's copending US patent application Docket No. 49502/000, entitled Pseudoplastic or Thixotropic Liquid Deodorant Product for Ostomy Pouches, both of which having been filed simultaneously herewith and are incorporated in their entirety herein by reference.

Another useful application of this invention is for an oven cleaner. Oven cleaners often contain high levels of ionic hydroxides and/or salts. Pseudoplastic formulations of the current invention allow the oven cleaner to be dispensed from an aerosol or from a pump spray onto the walls of the oven. Once on the wall the high stationary viscosity keeps the oven cleaner in contact with the soil and prevents the oven cleaner from migrating down the wall of the oven under the action of gravity and prevents pooling on the oven floor. Similarly this technology can be applied to other cleaners applied to walls.

The use of the thickening system is also particularly suited for an ostomy pouch deodorizer product. In this context, the combined low kinetic viscosity and high stationary viscosity permit a user to dispense the composition from a spray or aerosol container onto the interior walls of the ostomy pouch and the composition so dispensed will stay in place without slipping down to the bottom of the bag during use. While some of the deodorizing composition may get washed down the sides of the bags due to contact with incoming fecal material, much of the deodorizer material remains in place above the waste to deodorize the headspace. Since the composition so dispensed contains deodorizing components, those components will continue to deodorize the headspace within the pouch above the collected waste matter even as waste matter washes over portions of the pouch walls. Preferably, this allows for a portion of the composition (including its deodorizing components) to remain out of contact with the waste matter (and as such avoid or minimize inactivation or absorption of the deodorizing components by the waste matter itself). It should be noted that because the present invention thickening system is tolerant of high ionic strength conditions and does not lose its viscoelastic properties under such conditions, the product will substantially remain in place even though the waste material which flows over it has a high ionic strength. In using clays that have not been modified according to the present invention, the high ionic strength of the product itself and the waste material with which it may come in contact results in a collapse of the gel structure and the product cannot perform as intended.

Another possible use for the thickening system of the invention is a chlorine disinfectant or bleach for application to shower stall walls. In addition to the chlorinating agent the product can contain additional salts such as carbonates, phosphates for added detergency and cleaning. A product of the invention would be readily dispensed from a pump or aerosol but usefully remain on the surface where sprayed.

A further use is in a baking soda-containing toothpaste where the product is readily dispensed from a toothpaste tube but remains on the toothbrush with excellent stand-up.

The invention thickening system can be prepared from clays which produce pseudo-plastic solutions or suspensions when mixed with water. The most preferred systems are primarily of clays together with very minor amounts of organic thickeners. The clays for use in the present invention include, but are not limited to, synthetic or natural thickening clays having particle sizes generally less than about 200 nm, which clay has been externally reacted with a divalent, trivalent, or tetravalent metal cation. Preferably the clays are sodium magnesium silicate based and sodium lithium magnesium silicate based clays similar to hectorite. Particularly preferred are clays available as Laponite (Laporte Industries, Ltd, Cheshire, England) and Vee-Gum and Van Gel (Vanderbuilt Minerals Corp.). Other inorganic thickeners suitable for use in the invention include bentonite clays and calcium silicate. The clays may be used in amounts that are generally suitable for the product in which the system is to be employed, and those of ordinary skill in the respective product areas will know those levels. In the case of an ostomy deodorizer product they are generally used in amounts of 2-6% of the deodorizer formulation.

To prepare the thickening systems of the invention, the clay is thoroughly hydrated in water and then externally reacted with about 1×10⁻⁵ moles to 2×10⁻³ moles of a divalent, trivalent, or tetravalent metal cation per gram of clay; preferably a member selected from the group consisting of calcium, magnesium, strontium, barium, zinc, copper, manganese and iron, even more preferably zinc, copper, and iron (II). Most preferably the clay used in the instant invention is Laponite.

Organic polymers suitable for use in modulating the thickening system properties of the invention include, but are not limited to, xanthan gum, carboxymethylcellulose (or its alkali metal salts), polyacrylates (preferably with a molecular weight in the range of 100,000 to about 2,000,000), guar gum, sodium alginate, The most preferred gums are xanthan gum, gellan gum and iota carrageenan gum. When the organic polymers are used, they are used at levels of 0.01% to about 0.2%, preferably about 0.02% to about 0.1%, more preferably about 0.04% to about 0.08% of the deodorizing composition. The organic polymers generally help to prevent syneresis and other compatible materials having an antisyneresis property are suitable as well.

In general, the formulations of the invention are prepared by mixing the organic polymer (if used) with water (generally sprinkling it into water and mixing for at least about 15 minutes to obtain good hydration of the polymer. The clay is then hydrated in the water, preferably by heating it to from about 40° C. to about 80° C. preferably about 60° C. and rapidly mixing for from about 10 minutes to 2 hours preferably about 30 minutes. Optimum temperatures and mixing times may vary depending on the clay used. While rapidly mixing, a solution containing the divalent, trivalent, or tetravalent metal cation salt is added and the mixture is rapidly mixed for from about 5 minutes to 1 hour preferably about another 15 minutes. The mixture is then cooled to room temperature. The invention thickener may then be incorporated into formulations for any of a wide variety of products in generally the same manner that unmodified clay or other thickener would be used therein.

### EXAMPLES

The following examples exemplify, but do not limit, the present invention.

### Examples 1-4

Formulations of the instant invention are set forth in the table below.

| | Ex. 1 | Ex. 2 | Ex. 3 | Ex. 4 |
|---|---|---|---|---|
| | Weight | Weight | Weight | Weight |
| Component | % | % | % | % |
| Water | 88.300 | 88.150 | 88.300 | 88.60 |
| VEEGUM | —.— | 4.000 | —.— | —.— |
| Laponite RD | 4.000 | —.— | 4.000 | 4.000 |
| Xanthan Gum | 0.050 | 0.050 | 0.00 | 0.000 |
| Chloramine-T | 2.000 | 2.000 | 2.000 | 2.000 |
| Copper Chloride | 2.400 | 2.400 | 2.400 | 2.400 |
| Dihydrate (3.6%) | | | | |
| Na bicarbonate | 1.000 | 1.000 | 1.000 | 1.000 |
| Ca carbonate | 2.000 | 2.000 | 2.000 | 2.000 |
| Avanel S74 | —.— | —.— | 0.300 | —.— |
| Na lauryl sulfate | 0.050 | 0.200 | —.— | —.— |
| Fragrance | 0.200 | 0.200 | —.— | —.— |
| Total | 100.000 | 100.000 | 100.000 | 100.000 |

In each case, the Laponite or Veegum together with the xanthan gum are dispersed in the water in a high shear mixer. The dispersion is heated to 60° C. and stirred for 30 minutes. The mixture is then cooled to room temperature. The copper chloride is then slowly added and followed by 5 minutes of additional stirring. Next the sodium bicarbonate is added followed by 5 minutes of further stirring. Then the calcium carbonate is added, followed by 5 minutes of still more stirring. Then the chloramine-T is added and followed by 5 minutes additional stirring. Next, if present, the Avanel S74 (a sodium alkyl ether sulfonate available from) or sodium lauryl sulfate is added with an additional 5 minutes stirring. If fragrance is present, it is added with the surfactant and the entire mixture is stirred for 10 minutes.

The resulting compositions are placed into spray bottles and can be readily sprayed therefrom. The sprayed composition adheres to surfaces on which it is sprayed and remains where deposited despite the surface being held vertically.

### Example 5

An industrial gaseous malodorant deodorizer is formulated as follows:

| | |
|---|---|
| Chloramine-T | 2.0 |
| Calcium Carbonate | 2.0 |
| Sodium bicarbonate | 1.0 |
| Xanthan Gum | 0.05 |
| Laponite D | 4.0 |
| Copper sulfate (3.6%) | 2.4 |
| Fragrance | 0.2 |
| Water | 88.35 |
| Total | 100.00 |

The composition is sprayed onto a filter material which is placed in the flow path of a gaseous malodorant effluent which gaseous effluent has either or both of sulfur containing gaseous malodorants and/or short chain aliphatic acids. The effluent gas which has passes through the filter treated with the above composition is less odoriferous than the effluent gas prior to contacting the treated filter.

Alternatively or in conjunction with the above filter, the composition above is sprayed onto the one or more walls along the flow path of the effluent gas on its way to being discharged. The effluent gas which is discharged is less odoriferous than effluent gas which has not passed along a flow path having the above composition thereon.

### Example 6

An oven cleaner dispensed from a pump spray can be formulated as follows:

| | |
|---|---|
| Sodium hydroxide | 2.0 |
| Sodium carbonate | 1.0 |
| Xanthan Gum | 0.05 |
| Laponite D | 5.0 |
| Dowfax 2A1 | 0.5 |
| Zinc sulfate (4%) | 1.5 |
| Water | 89.95 |
| Total | 100.00 |

### Example 7

A baking soda-containing toothpaste is formulated as follows

| | |
|---|---|
| Sodium lauryl sulfate | 1.0 |
| Sodium bicarbonate | 5.0 |
| Xanthan Gum | 0.05 |
| Laponite D | 2.0 |
| Glycerin | 35.0 |
| Abrasive silica | 15.0 |
| Thickening silica | 4.0 |
| CMC | 0.5 |
| Zinc sulfate (4%) | 0.5 |
| Sodium MFP | 0.78 |
| Water | 36.17 |
| Total | 100.00 |

We claim:

1. A high ionic strength tolerant clay thickening system comprising a clay and a clay modifying metal cation selected from the group consisting of divalent, trivalent, and tetravalent metal cations, where said metal cation has been externally reacted with said clay.

2. The system of claim 1 wherein said clay is selected from sodium lithium magnesium silicate based colloidal clays.

3. The system of claim 1 wherein said clay has a particle size of generally not more than about 200 nanometer.

4. The system of claim 1 wherein said metal cation is selected from the group consisting of calcium, magnesium, strontium, barium, zinc, copper, manganese and iron

5. The system of claim 4 wherein said metal cation is selected from the group consisting of zinc, copper, and iron (II).

6. The system of claim 1 wherein said clay modifying metal cation is present in an amount of from 1×10⁻⁵ moles to 2×10⁻³ moles of said clay modifying metal cation per gram of clay.

7. The system of claim 1 further comprising an auxiliary organic polymer thickener selected from the group consisting of carboxymethylcellulose (and its alkali metal salts), polyacrylates, xanthan gum, guar gum, and sodium alginate.

8. The system of claim 7 wherein said auxiliary organic polymer thickener is present in an amount of about 0.5% to about 3.3% relative to said clay.

9. A thickened product formulation comprising an active agent and the thickening system of claim 1.

10. The thickened product formulation of claim 9 selected from the group consisting of toothpaste, oven cleaner, household cleaner, ostomy deodorizer, shower cleaner, and bathroom disinfectant.

11. The thickening system of claim 1 further comprising about 0.001 to about 4 mole/liter ions of a performance enhancing ionic material.

12. The thickening system of claim 11 in which the performance enhancing material is selected from the group consisting of salts and alkalis.

13. The thickening system of claim 12 in which the performance enhancing material is selected from the group consisting of monovalent metal bicarbonates, carbonates, hypochlorites, phosphates, chlorites, permanganates, silicates, sulfites, nitrites, hydroxides chloramine-t, chloramine-b, cyanurates, anionic surfactants or mixtures thereof.
